(19) United States
(12) Patent Application Publication
(10) Pub. No.: US 2010/0089104 A1
(43) Pub. Date: Apr. 15, 2010

(54) PNEUMATICALLY OPERATED BARRIER LOCK

(76) Inventor: Michael John Watmough, New South Wales (AU)

Correspondence Address: KNOBBE MARTENS OLSON & BEAR LLP, 2040 MAIN STREET, FOURTEENTH FLOOR, IRVINE, CA, 92614, US

(21) Appl. No.: 12/439,993

(22) PCT Filed: Sep. 4, 2007
(86) PCT No.: PCT/AU07/01294

§ 371 Date: Dec. 14, 2009

(30) Foreign Application Priority Data
Sep. 4, 2006 (AU) 2006904808
Mar. 12, 2007 (AU) 2007901226

(51) Int. Cl. E05B 65/00; E05B 15/00

(52) U.S. Cl. 70/57; 70/266

(57) ABSTRACT

A pneumatically operated barrier lock is provided. The barrier lock includes a body and a locking pin slidably mounted on the body for movement along a path between an extended position for engaging a catch and a retracted position for disengaging the catch. The lock also includes a pneumatic cylinder in connection with a pressure source and actuating the locking pin between the extended position and the retracted position. An opposite end of the cylinder is adapted for connection to a relatively low second pressure source. A second pressure source connectable to end of the pneumatic cylinder biases the piston away therefrom and generates a first biasing apparatus, in form of a pneumatic spring, which biases the locking pin toward the retracted position. A blocking member is hingedly connected, about a pivot axis, to the body and is selectively movable between a first position and a second position.

### FIELD OF THE INVENTION

The present invention relates to a pneumatically operated barrier lock. The invention has been developed primarily for use in locking barriers such as doors, windows, grilled, barred or screen-type security barriers, security gates, movable vehicular control barriers or security barriers in high security applications, such as in prisons, banks and armories, or to secure high strength doors or barriers such as “blast” doors or fire containment screens or doors or in marine applications for water isolation or containment doors or barriers. The invention can also be used to secure barriers of item containment enclosures, such as safes, security enclosures or storage cabinets. However, the invention is not limited to these barriers or applications.

### BACKGROUND OF THE INVENTION

Previously contemplated barrier locks may include a locking tongue operated by manually operated levers or keys. Such manually operated locks do not typically have a bias to revert to either a locked or an unlocked state. Locks that do have a bias suffer from the disadvantage that the bias must be less than that which can be overcome by a user operating the lock. To address this disadvantage, some previously contemplated locks have locking mechanisms that are driven electrically or hydraulically.

Electrically powered locks typically include electric motors for driving the lock into a locked state and driving the lock back into an unlocked state. Such locks have an inherent problem of how to revert the lock to a desired locked or unlocked state if electrical power supply fails. To overcome this problem, electrically powered locks are typically biased into an unlocked state in the event of loss of electrical power. Electrically powered locks without such a bias are dangerous when used to secure people or animals, as they can prevent egress when the lock loses power. Electrically powered locks are also typically expensive to manufacture.

Another previously contemplated lock is electro-magnetically operated. However, such locks are relatively large and are therefore expensive to manufacture and time-consuming to install. Also, it can be difficult to maintain the large, low-voltage current required to maintain an electro-magnetic lock in a desired locked or unlocked state.

Solenoid operated locks have also been contemplated. Solenoids are, however, not particularly powerful. Moreover, solenoids apply load instantly, with maximum power typically being delivered in the middle of the solenoids travel, rather than at the beginning and end of travel, where maximum power is usually desired for driving locks.

Another problem with all electrically operated locks is electrical induction and heat. The induction current from electrically operated locks can cause interference with other electronic devices and vice versa.

Previously contemplated pneumatically operated locks use compressed air to impart a load to engage and maintain a lock in a locked state and to unlock a lock. Loss of pneumatic control can compromise the integrity of such known locks.

Previously contemplated pneumatically operated barrier locks requires retained pressurised air to maintain the lock in a locked or an unlocked configuration. A disadvantage of this lock it that it unlocks or locks if the retained air pressure reduces, for example due to a lock component failure or due to sabotage.

### OBJECT OF THE INVENTION

It is the object of the present invention to overcome or ameliorate one or more of the is disadvantages of the prior art, or at least to provide a useful alternative.

### SUMMARY OF THE INVENTION

In a first aspect, the present invention provides a pneumatically operated barrier lock comprising:
a body;
a primary locking pin slidably mounted to the body for movement along a path between an extended position for engaging a catch operatively associated with said pneumatically operated barrier lock and a retracted position for disengaging the catch;
a pneumatic cylinder adapted for connection to a first pressure source and actuable on said primary locking pin for moving said primary locking pin between said extended position and said retracted position;
a first biasing apparatus for biasing said primary locking pin toward said retracted position;
a blocking member movable between a first position and a second position, wherein in said first position said blocking member is clear of said path to allow retraction of said primary locking pin, and wherein in said second position said blocking member blocks said path to prevent retraction of said primary locking pin.

The first biasing apparatus is preferably a spring, such as a mechanical spring or a pneumatic spring. The pneumatic cylinder is preferably adapted for connection to a second pressure source, opposed to said first pressure source, to generate said pneumatic spring.

The blocking member is preferably hingedly connected, about a pivot axis, to said body and selectively movable between said first position and said second position. Alternatively, the blocking member is slidably connected to the body and selectively movable between said first position and said second position. The blocking member preferably includes a recess configured to at least partially enclose an end of said primary locking pin when said blocking member is in said second position, to prevent said primary locking pin and said blocking member from being disengaged by movement of said blocking member about said pivot axis. Alternatively, the blocking member includes an aperture aligned with said primary locking pin, when said blocking member is in said first position, to disengage said pin from said blocking member.

A second biasing apparatus is preferably provided for biasing said blocking member into said second position. Alternatively, the second biasing apparatus is adapted for biasing said blocking member into said first position. The second biasing apparatus is preferably a spring, such as a mechanical spring or a pneumatic spring.

A pneumatic actuator is preferably provided for selectively moving said blocking member between said first position and said second position. The pneumatic actuator is preferably adapted to receive pressure from a third pressure source. The third pressure source is preferably independent of said first pressure source. Alternatively, the pneumatic cylinder and the pneumatic actuator are both adapted to receive pressure from said first pressure source via respective valves.

A manually actuable assembly is preferably engageable with said blocking member to move said blocking member from said second position to said first position. The manually actuable assembly is preferably biased by said third pressure source away from engagement with said blocking member. A third resilient biasing apparatus is preferably provided for biasing said manually actuable assembly toward engagement with said blocking member, said third resilient biasing apparatus being adapted to move said manually actuable assembly into engagement with said blocking member upon pressure from said third pressure source falling below a predetermined level or upon disconnection of said third pressure source. The manually actuable assembly is preferably a cam assembly.

A controller is preferably provided for controlling application and disconnection of pressure to said pneumatic cylinder and to said pneumatic actuator from said first pressure source and/or said third pressure source. At least one first pressure sensor is preferably provided for sensing the pressure provided to said pneumatic cylinder, said controller being responsive to said first pressure sensor. At least one second pressure sensor is preferably provided for sensing the pressure provided to said pneumatic actuator, the controller being responsive to said second pressure sensor.

At least one first proximity sensor is preferably provided for sensing the position of said primary locking pin, said controller being responsive to said first proximity sensor. At least one second proximity sensor is preferably provided for sensing the position of said blocking member, said controller being responsive to said second proximity sensor.

In a first family of embodiments, upon receiving a locking command, said controller is preferably adapted to:
control the application of pressure to said pneumatic cylinder to move said primary locking pin from the retracted position to the extended position;
wait for said blocking member to move into the second position; and
control the release of pressure from said pneumatic cylinder.

In the first family of embodiments, upon receiving an unlocking command, said controller is preferably adapted to:
control the application of pressure to said pneumatic cylinder;
control the application of pressure to said pneumatic actuator to move said blocking member into said first position; and
control the release of pressure from said pneumatic cylinder.

In another family of embodiments, upon receiving a locking command, said controller is preferably adapted to:
control the application of pressure to said pneumatic cylinder to move said primary locking pin from the retracted position to the extended position;
control the application of pressure to said pneumatic actuator to move said blocking member into the second position; and
control the release of pressure from said pneumatic cylinder.

In this second family of embodiments, upon receiving an unlocking command, said controller is preferably adapted to:
control the application of pressure to said pneumatic cylinder;
wait for the blocking member to move into said first position; and
control the release of pressure from said pneumatic cylinder.

In a second aspect, the present invention provides a locking assembly comprising:
a pneumatically operated barrier lock as defined in the first aspect above;
a secondary lock including one or more secondary locking pins movable between a retracted position and an extended position;
wherein the primary locking pin is engageable with said secondary lock to drive said one or more secondary locking pins from their retracted position to their extended position.

The secondary lock preferably comprises a plurality of said secondary locking pins and a mechanism actuable thereon for driving the secondary locking pins from their retracted is position to their extended position, said mechanism being operatively engageable by the primary locking pin. The mechanism preferably includes a cam operatively engageable by the primary locking pin.

A fourth biasing apparatus is preferably provided for biasing said one or more secondary locking pins toward their retracted position.

In a third aspect, the present invention provides a method of locking an article, said method comprising the steps of:
biasing a primary locking pin toward a retracted position;
applying a pneumatic pressure to said primary locking pin to drive said primary locking pin along a path from said retracted position into an extended position against said biasing to engage a catch operatively associated with said primary locking pin;
moving a blocking member from a first position free of said path into a second position blocking said path; and
removing said pneumatic pressure.

Upon removing said pneumatic pressure, and with the blocking member in said second position, said primary locking pin preferably bears against said blocking member.

### BRIEF DESCRIPTION OF THE DRAWINGS

Preferred embodiments of the invention will now be described, by way of examples only, with reference to the accompanying drawings, in which:

FIG. 1 is a front elevational view of a preferred embodiment of a pneumatically operated barrier lock;

FIGS. 2A and 2B are plan views of the blocking member and associated pneumatic actuator of the pneumatically operated barrier lock of FIG. 1, respectively shown engaged with and disengaged from the primary locking pin;

FIGS. 3A, 3B and 3C illustrate a first alternative embodiment of the blocking member and pneumatic actuator of FIGS. 2A and 2B;

FIGS. 4A and 4B illustrate a second alternative embodiment of the blocking member and pneumatic actuator of FIGS. 2A and 2B;

FIG. 5 is a schematic side elevational view of the manually actuable cam assembly of the pneumatically operated barrier lock of FIG. 1, with the cam assembly shown disengaged from the blocking member;

FIG. 6 is a schematic side elevational view of the manually actuable cam assembly of the pneumatically operated barrier lock of FIG. 1, with the cam assembly shown engaged with the blocking member;

FIG. 7 is a plan view of the engaged cam assembly and blocking member of FIG. 6, prior to actuation of the cam assembly;

FIG. 8 is a plan view of the engaged cam assembly and blocking member of FIG. 6, after actuation of the cam assembly, showing the blocking member rotated to disengage the primary locking pin.

FIGS. 9A and 9B illustrate movement of the locking pin of the pneumatically operated barrier lock of FIG. 1 between a retracted position and an extended position;

FIGS. 10, 10A, 10B and 10C illustrate movement of the locking pin of the pneumatically operated barrier lock of FIG. 1 between an extended position and a retracted position;

FIG. 11 is a side elevational view of the lock of FIG. 1 disengaged from an associated barrier;

FIG. 12 is side elevational view of the lock of FIG. 1 engaged with an associated barrier;

FIGS. 13A and 13B are, respectively, an assembled and an exploded side elevational view of a secondary lock for use with the primary lock of FIG. 1;

FIG. 14 is a side elevational view of the lock of FIG. 1 mounted adjacent a barrier and disengaged from the secondary lock of FIGS. 13A and 13B, which is mounted to the barrier; and

FIG. 15 is a side elevational view of the lock of FIG. 1 mounted adjacent a barrier and engaged with the secondary lock of FIGS. 13A and 13B, which is mounted to the barrier.

### PREFERRED EMBODIMENTS OF THE INVENTION

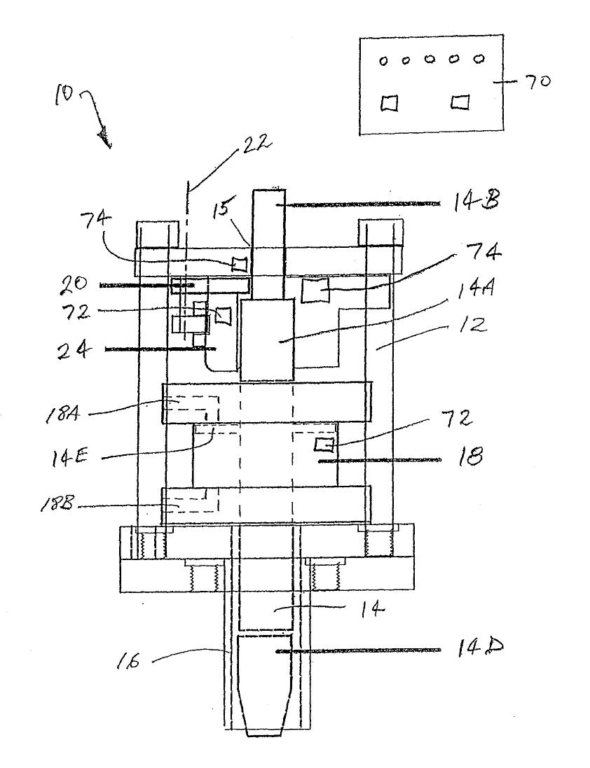

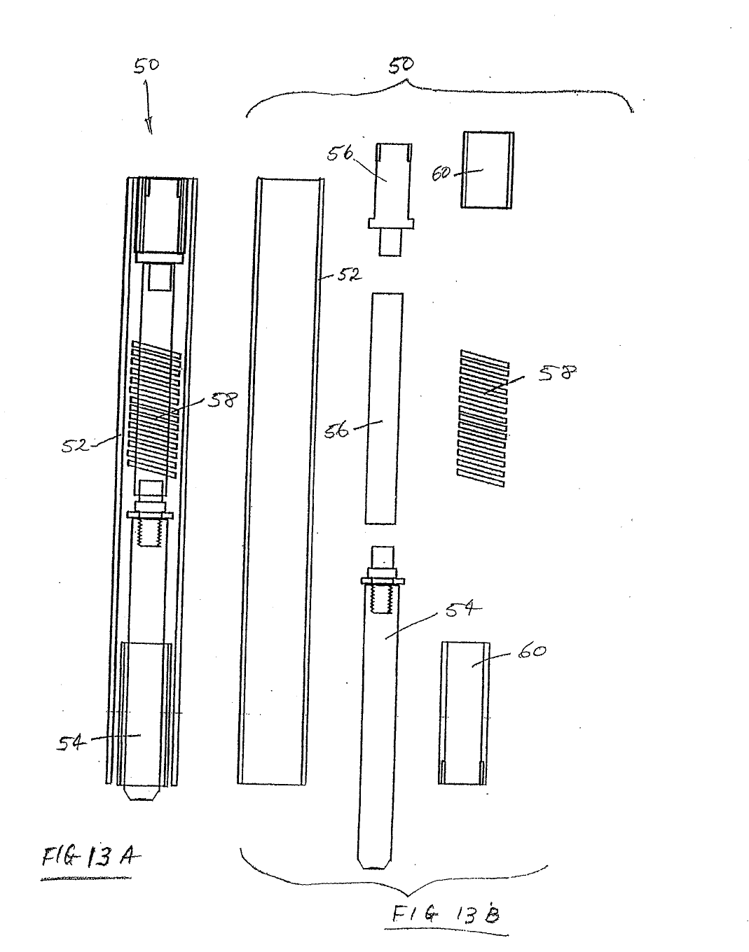

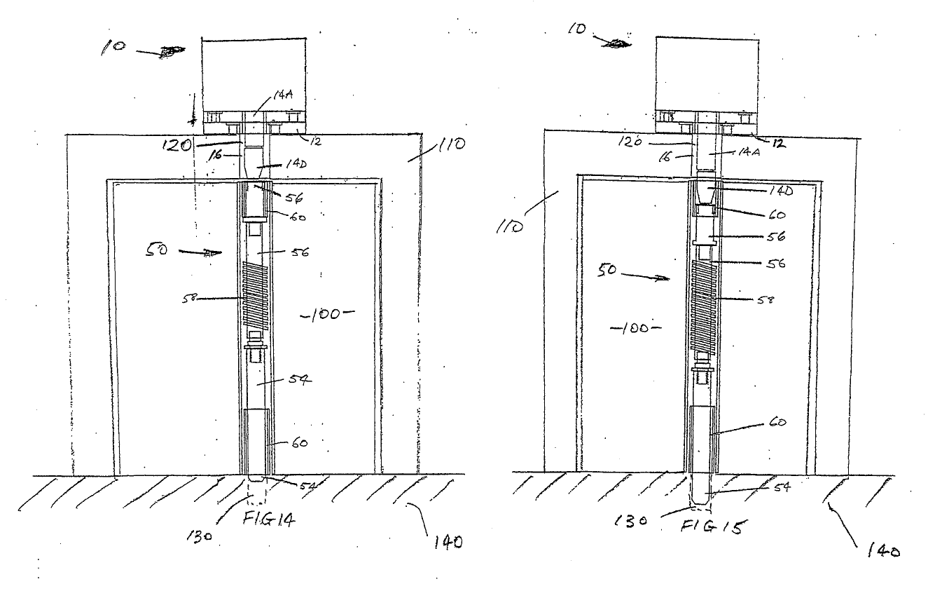

Referring firstly to FIG. 1 of the drawings, there is shown a pneumatically operated barrier lock 10. The lock 10 comprises a body 12 and a primary locking pin 14 slidably mounted in a sleeve portion 16 of the body for movement along a path between an extended position for engaging a catch and a retracted position for disengaging the catch. The pin 14 includes a shank 14A having a reduced diameter portion 14B at one end, defining a shoulder 14C between the reduced diameter portion 14B and the remainder of the shank 14A. A removable head 14D is connected to an opposite end of the shank 14A. The reduced diameter portion 14B is slidable through an aperture 15 in the body 12. The lock 10 also includes a pneumatic cylinder 18 having one end 18A adapted for connection to a first pressure source (not shown). The primary locking pin 14 extends through the pneumatic cylinder 18 and a piston 14E is connected to the primary locking pin 14 at a position within the cylinder 18. Pressure injected into end 18A of the pneumatic cylinder 18 biases the piston 14E away therefrom and thereby biases the primary locking pin 14 toward the extended position. The opposite end 18B of the pneumatic cylinder 18 is adapted for connection to a relatively low second pressure source (not shown). The low second pressure source connected to end 18B of the pneumatic cylinder 18 biases the piston 14E away therefrom and generates a first biasing apparatus, in the form of a pneumatic spring, which biases the primary locking pin 14 toward the retracted position. A supplementary spring (not shown) is also provided for biasing the pin 14 toward its retracted position in the event that the pneumatic spring fails. The supplementary spring is provided either in the lock 10 or in a secondary lock (described below with reference to FIGS. 13A-15) used in conjunction with lock 10.

A blocking member 20 is hingedly connected, about a pivot axis 22, to the body 12 and is selectively movable between a first position and a second position. In the first position, the blocking member 20 allows retraction of the primary locking pin 14 along the path from the extended position to the retracted position under the bias of the pneumatic spring. In the second position, the blocking member 20 engages an end of the primary locking pin 14 to prevent retraction of the primary locking pin 14 from the extended position to the retracted position. The blocking member 20 need only partially engage the primary locking pin 14 to block the path and prevent retraction of the pin 14.

In some embodiments, the blocking member is also adapted to engage the shoulder 14C of the primary locking pin 14 to prevent the pin 14 overshooting its retracted position. In other embodiments, the retracted position of the primary locking pin 14 is limited by the stroke of the pneumatic cylinder 18

A pneumatic actuator 24 is provided for selectively moving the blocking member 20 between the first and second positions. The pneumatic actuator 24 is adapted to receive pressure from a third pressure source (not shown), independent of the first and second pressure sources.

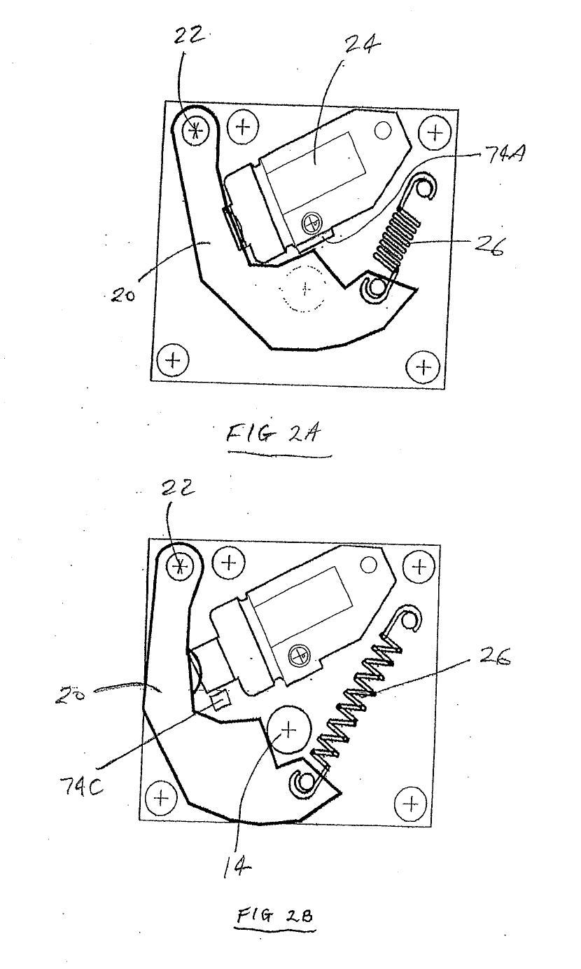

The embodiment shown in FIGS. 2A and 2B represents a “maintain secure” configuration, wherein the lock 10 is maintained in a locked configuration upon disconnection or failure of the first and/or third pressure supplies. In this embodiment, the blocking member 20 takes the form of a flat plate. A tension spring 26 is connected between the blocking member and the body 12 to bias the blocking member 20 into the second position, as shown in FIG. 2A, in which retraction of the pin 14 is prevented. If the pin 14 is extended and pressure supply from the third pressure source is disconnected, or fails, the pneumatic actuator 24 exerts no force on the blocking member 20 and the tension spring 26 biases the blocking member 20 into the second position, as shown in FIG. 2A, and/or retains the blocking member 20 in the second position. To move the blocking member 20 into the first position with respect to the pin 14, as shown in FIG. 2B, the pneumatic actuator 24 is actuated, or a manual force is applied to the blocking member 20, to override the bias of the tension spring 26 and drive the blocking member 20 out of alignment with the pin 14 to allow the pin 14 to be retracted by the bias of the pneumatic spring (or the supplementary spring—not shown).

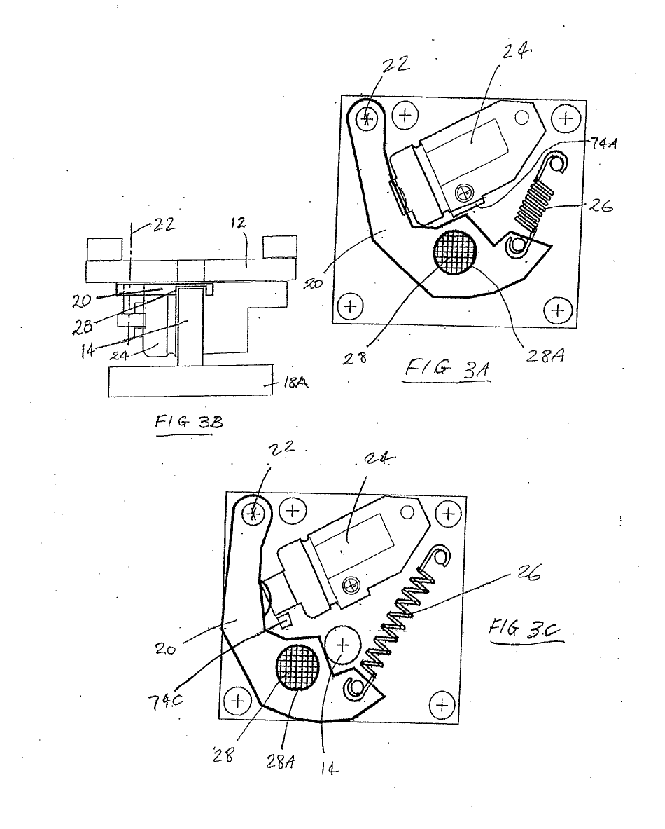

The embodiment shown in FIGS. 3A and 3B represents an “interlock secure” configuration, wherein the lock 10 is blocking member 20 and pin 14 are interlocked and the lock 10 is retained in a locked configuration upon disconnection or failure of the first and/or third pressure supplies. In this embodiment, the blocking member 20 takes the form of a flat plate with a recess 28 therein. A tension spring 26 is connected between the blocking member and the body 12 to bias the blocking member 20 into the second position, as shown in FIG. 3A. If the pin 14 is extended and pressure supply from the third pressure source is disconnected, or fails, the pneumatic actuator 24 exerts no force on the blocking member 20 and the tension spring 26 biases the blocking member 20 into the second position, as shown in FIG. 3A, and/or retains the blocking member 20 in the second position. In the second position, the recess 28 encloses an end of the pin 14, as shown in FIG. 3B, to prevent the pin 14 and the blocking member 20 from being disengaged by movement of the blocking member 20 about the pivot axis 22. Accordingly, to move the blocking member 20 into the first position, as shown in FIG. 3C, the pin 14 must first be extended out of engagement with the recess 28 to allow the blocking member 20 to be rotated out of alignment with the pin 14. With the blocking member in the first position, as shown in FIG. 3C, the pin 14 can be retracted by the bias of the pneumatic spring (or the supplementary spring—not shown).

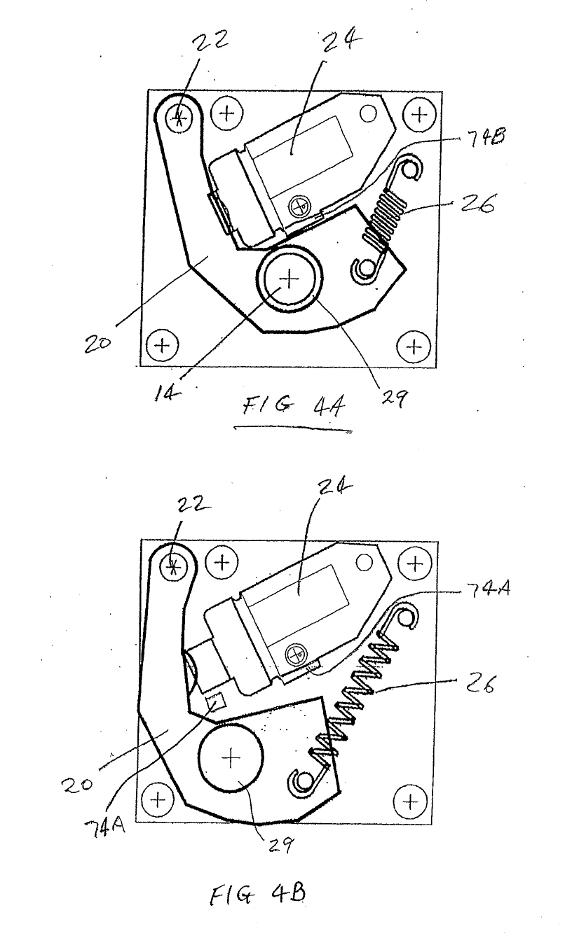

The embodiment shown in FIGS. 4A and 4B represents a “fail safe” configuration, wherein the lock 10 is biased into an unlocked configuration upon disconnection or failure of the first and/or third pressure supplies. In this embodiment, the blocking member 20 takes the form of a flat plate having an aperture 29 therein. A tension spring 26 is connected between the blocking member and the body 12 to bias the blocking member 20 into the first position, as shown in FIG. 4A. If the pin 14 is extended and pressure supply from the third pressure source is disconnected, or fails, the pneumatic actuator 24 exerts no force on the blocking member 20 and the tension spring 26 biases the blocking member 20 into the first position, as shown in FIG. 4A. In this position, the pin 14 is aligned with the aperture 29 and is thereby free to move into its retracted position under the bias of the pneumatic spring (or supplementary compression spring—not shown). To move the blocking member 20 into the second position, as shown in FIG. 4B, the pin 14 must first be moved into its extended position and the pneumatic actuator 24 actuated to override the bias of the tension spring 26 and drive the blocking member 20 into alignment with the pin 14.

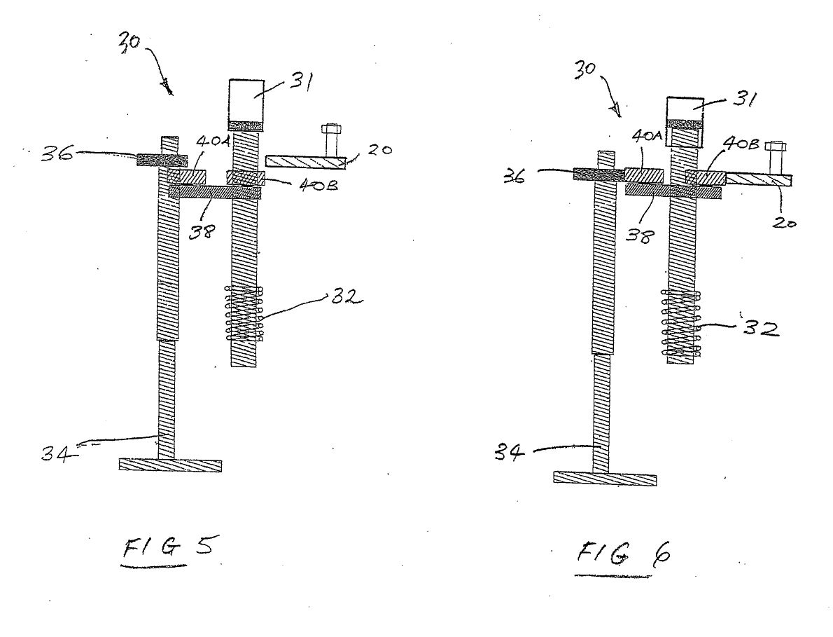

For embodiments having a blocking member configured as shown in FIGS. 2A and 2B or FIGS. 4A and 4B, a manually actuable cam assembly 30 is engageable with the blocking member 20 for moving the blocking member 20 out of engagement with the pin 14. The cam assembly 30 is biased, by a pneumatic cylinder 31 connected to the third pressure source (the pressure source connected to the pneumatic actuator 24), away from engagement with the blocking member 20. However, a third biasing apparatus, in the form of a compression spring 32, biases the cam assembly 30 toward engagement with the blocking member 20. The compression spring 32 applies a force to the cam assembly 30 that is less than the force applied by the third pressure source under normal operating conditions, such that the cam assembly 30 is normally disengaged from the blocking member 20, as shown in FIG. 5, thereby rendering it inoperative. However, upon pressure from the third pressure source falling below a predetermined level or upon disconnection of the third pressure source, the compression spring 32 biases the cam assembly 30 into operative engagement with the blocking member 20, as shown in FIGS. 6, 7 and 8.

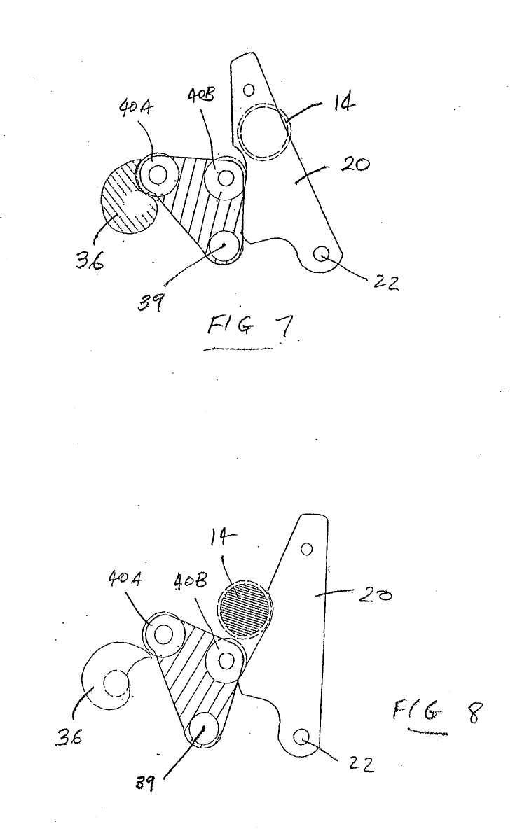

The cam assembly 30 includes a rotatable handle 34 connected to a cam 36. The cam is engageable with a bearing plate 38 that is rotatable about an axis 39 and which carries two cam bearings 40A and 40B. Cam bearing 40A is engageable with the cam 36 and cam bearing 40B is engageable with the blocking member 20. When the cam assembly 30 is operatively engaged with the blocking member 20, as shown in FIG. 7, rotation of the handle 34 causes the cam 36 to engage and rotate the bearing plate 38. During rotation of the bearing plate 38, the cam bearing 40B engages the blocking member 20 and causes the blocking member 20 to rotate about axis 22, thereby driving the blocking member 20 is out of engagement with the pin 14, as shown in FIG. 8.

A controller 70 is provided for controlling application and disconnection of pressure to the pneumatic cylinder 18 and to the pneumatic actuator 24 via solenoid valves (not shown). Pressure sensors 72 are provided for sensing the pressure provided to the pneumatic cylinder 18 and the pneumatic actuator 24. The controller 70 is responsive to these pressure sensors 72. Proximity sensors 74 are provided for sensing the position of the pin 14 and the blocking member 20. The controller 70 is also responsive to these proximity sensors 74. Additional pressure sensors (not shown), to which the controller 70 is responsive, are also provided to monitor pressure levels in various pneumatic components of the lock 10 to detect pressure failure or pressure conditions that fall outside of normal operating ranges. In the event of adverse pressure conditions, the controller 70 illuminates indicators and activates an alarm (not shown).

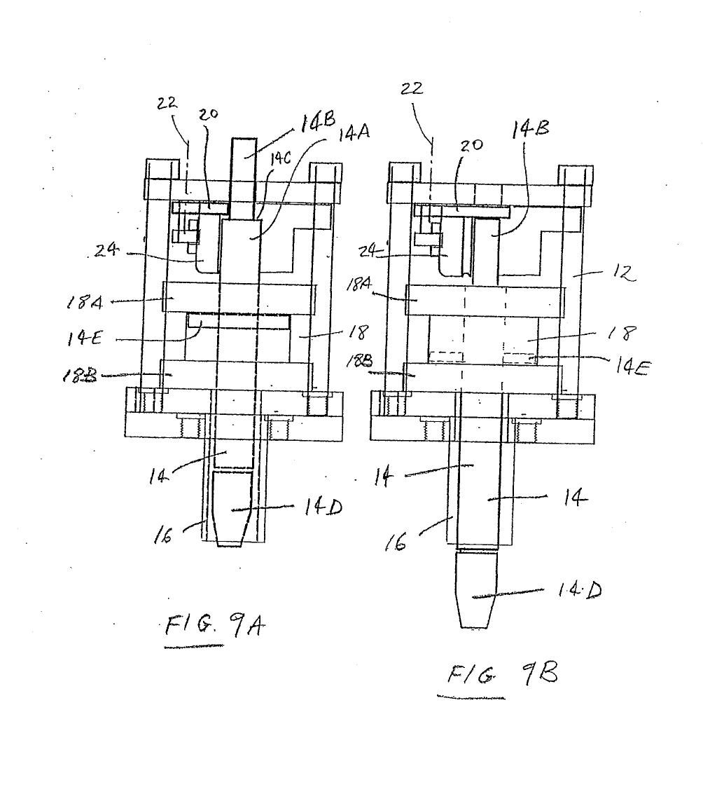

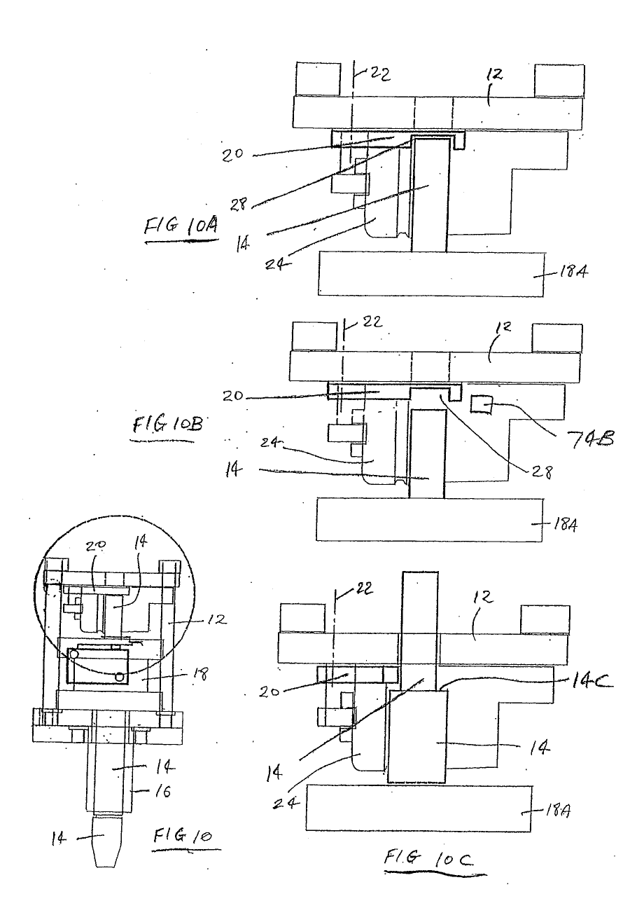

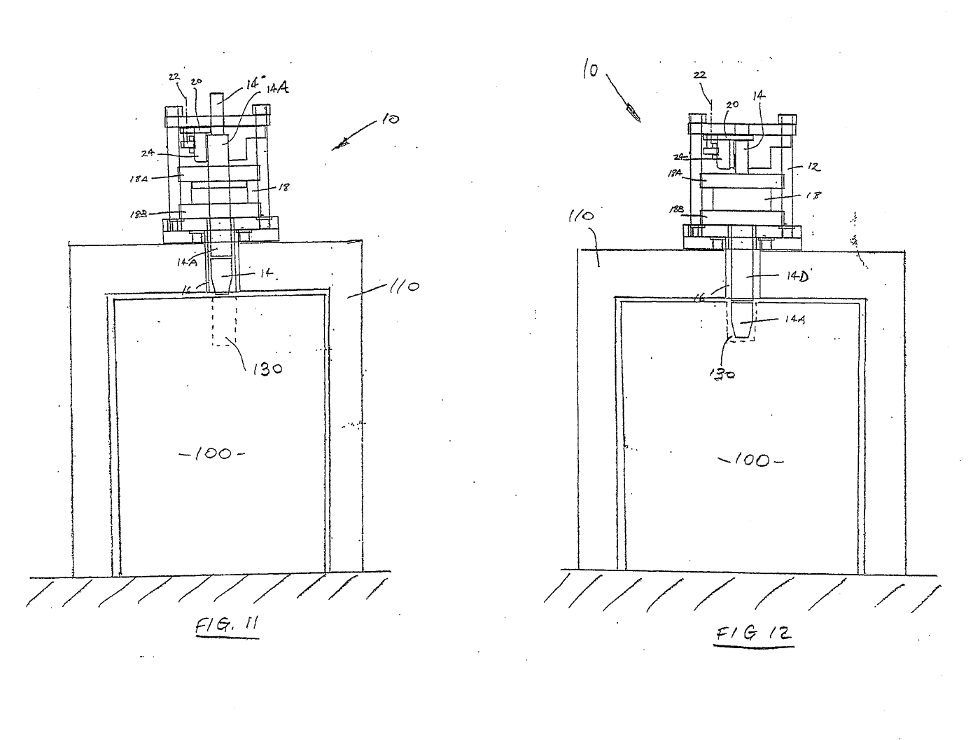

In use, for embodiments having a blocking member 20 configured as shown in FIGS. 2A and 2B or 3A, 3B and 3C, to engage the lock 10 upon receiving a locking command, the controller 70 is adapted to control the application of pressure from the first pressure source to the pneumatic cylinder 18, via a solenoid valve (not shown), to move the pin 14 from the retracted position shown in FIG. 9A to the extended position shown in FIG. 9B. During this movement, the blocking member 20 is biased against the side of the pin 14 by the tension spring 26. Once the pin reaches the extended position, the blocking member 20 moved past the end of the pin 14, under the bias of spring 26, into the second position shown in FIGS. 2A, 3A and 9B, in which the blocking member aligns with the pin 14. The controller 70 receives a signal from proximity sensor 74A when the blocking member 20 is in the second position. In response to this signal, the controller 70 controls disconnection of pressure from the first pressure source to the pneumatic cylinder 18, which in turn causes the pin 14 to be retracted, by the pneumatic spring, into engagement with the blocking member 20, as shown in FIG. 10A.

In use, for embodiments having a blocking member 20 configured as shown in FIGS. 2A and 2B or 3A, 3B and 3C, to disengage the lock 10 upon receiving an unlocking command, the controller 70 is adapted to control the application of pressure from the first pressure source to the pneumatic cylinder 18, via a solenoid valve (not shown), to drive the pin 14 to its fully extended position, as shown in FIG. 10B. The controller 70 receives a signal from a proximity sensor 74B when the pin 14 has been fully extended. In response to this signal, the controller 70 controls the connection of pressure from the third pressure source to the pneumatic actuator 24, via a solenoid valve (not shown), to drive the blocking member 20 into the first position, as shown in FIGS. 2B and 3C, against the bias of the spring 26. The controller 70 receives a signal from a proximity sensor 74C when the blocking member 20 is in the first position. In response to this signal, the controller 70 controls disconnection of pressure from the first pressure source to the pneumatic cylinder 18, which in turn causes the pin 14 to fully retract, under the bias of the pneumatic spring, into the retracted position shown in FIG. 10C.

In use, for embodiments having a blocking member 20 configured as shown in FIGS. 4A and 4B, to engage the lock 10 upon receiving a locking command, the controller 70 is adapted to control the application of pressure from the first pressure source to the pneumatic cylinder 18, via a solenoid valve (not shown), to move the pin 14 from the retracted position shown in FIG. 9A to the extended position shown in FIG. 9B. The controller 70 receives a signal from a proximity sensor 74B when the pin 14 has been fully extended. In response to this signal, the controller 70 controls the application of pressure from the third pressure source to the pneumatic actuator 24, via a solenoid valve (not shown), to drive the blocking member 20 into the second position, as shown in FIG. 4B, against the bias of spring 26. The controller 70 receives a signal from a proximity sensor 74A when the blocking member 20 is in the second position. In response to this signal, the controller 70 controls disconnection of pressure from the first pressure source to the pneumatic cylinder 18, which in turn causes the pin 14 to retract, under the bias of the pneumatic spring, into engagement with the blocking member 20, as shown in FIG. 10A.

In use, for embodiments having a blocking member 20 configured as shown in FIGS. 4A and 4B, to disengage the lock 10 upon receiving an unlocking command, the controller 70 is adapted to control the application of pressure from the first pressure source to the pneumatic cylinder 18, via a solenoid valve (not shown), to move the pin 14 to its fully extended position, as shown in FIG. 10B. The controller 70 receives a signal from a proximity sensor 74A when the pin 14 has been fully extended. In response to this signal, the controller 70 controls the disconnection of pressure from the third pressure source to the pneumatic actuator 24, which causes the spring 26 to bias the blocking member 20 into the first position, as shown in FIG. 4A. The controller receives a signal from a proximity sensor 74B when the blocking member 20 has been properly disengaged from the pin 14. In response to this signal, the controller 70 controls disconnection of pressure from the first pressure source to the pneumatic cylinder 18, which in turn causes the pin 14 to fully retract, under the bias of the pneumatic spring, into the retracted position shown in FIG. 10C.

As shown in FIGS. 11 and 12, the lock 10 can be used as a primary lock for directly locking a barrier 100. The lock 10 is mounted to a frame 110 surrounding the barrier 100 and penetrates through a small aperture 120 in the frame 110 and into a catch 130 in the barrier 100, as shown in FIG. 10. In alternative embodiments (not shown), the catch 130 can be mounted on the face of the barrier 100, or the lock 10 can be mounted to the barrier and can engage a catch in the frame 110 or on a face of the frame. In a yet further embodiment (not shown), the face of the barrier 100 can act as the catch 130.

The lock 10 can also be used as a primary lock acting in conjunction with a secondary lock 50. An example of such a secondary lock 50 is shown in FIGS. 13A and 13B. The secondary lock 50 comprises a tubular member 52 and a secondary locking pin 54 slidably mounted in the tubular member 52. A rigid shaft 56 is engaged with the secondary locking pin 54 and is adapted for engagement by the pin 14 of lock 10. The secondary locking pin 54 and shaft 56 are biased by a compression spring 58 toward a retracted position as shown in FIG. 12. Bushings 60 are also provided in either end of the tubular member 52.

As shown in FIGS. 14 and 15, when used with a secondary lock, the primary lock 10 can be secured to a frame 110 surrounding a barrier 100 to be locked and the secondary lock can be mounted to a surface of the barrier 100. The primary locking pin 14 is extendable through a small aperture 120 in the frame 110. To actuate the secondary lock 50, the lock 10 is engaged to extend the locking pin 14 through the aperture 120 in the frame 110 and into the tubular member 52, which acts as a catch between the primary lock 10 and the barrier 100, for engagement with the shaft 56. Engagement of the primary locking pin 14 with the shaft 56 drives the secondary locking pin 54 from the tubular member 52 into engagement with a further catch 130 formed as a recess in the floor 140.

It will be appreciated that the illustrated lock 10 provides many advantages over known pneumatically operated barrier locks. For example:
the lock 10 can be mounted external to a barrier to be locked and engageable with a secondary lock 50 mounted on a surface of the barrier, thereby not significantly reducing the structural integrity of the barrier;
external mounting of the lock 10 relative to the barrier reduces the opportunity for the lock 10 to be tampered with or damaged;
the lock 10 can be configured “maintain secure” or “interlock secure” by using the blocking member 20 of FIGS. 2A and 2B or 3A, 3B and 3C, where engagement of the blocking member 20 with the pin 14 retains the pin 14 in its extended position even if pneumatic pressure supply to the pneumatic cylinder 18 and/or pneumatic actuator 24 is disrupted;
the lock 10 can be configured “fail safe” by using the blocking member 20 of FIGS. 4A and 4B, where disengagement of the blocking member 20 from the pin 14 frees the pin 14 for retraction if pneumatic pressure supply to the pneumatic actuator 24 is disrupted;
the structure and configuration of the lock 10 renders it suitable for applying large driving forces to the pin 14, such as may be required to drive camming arrangements in secondary locks or to overcome ceasing of lock components caused by sabotage of the lock 10;
the structure and configuration of the lock 10 also renders it suitable for driving other external devices;
the structure and configuration of the lock 10 also renders it suitable for mounting at any height or distance above the top of or from the side of a barrier; and
the head 14A of the pin 14 can be removed and replaced with a new head if damage or wear occurs or if a head of different length and/or diameter is required.

Whilst the invention has been described with reference to specific embodiments, it will be appreciated that it may also be embodied in other forms. For example, in other embodiments (not shown):
the first pressure source can supply pressure to both the pneumatic cylinder 18 and the pneumatic actuator 24 via respective valves;
the pin 14 can be provided with a ratchet configuration extending axially therealong and being engageable by the blocking member 20 to prevent retraction but allow extension of the pin;
manual pneumatic control can be provided in addition to or instead of the controller 70 and its associated sensors 74;
the secondary lock 50 can comprise a plurality of secondary locking pins 54 and a cam mechanism actuable thereon, the cam mechanism being engageable by the pin 14 of lock 10 to drive the secondary locking pins 54 into engagement with an adjacent fixed structure;
the pneumatic spring generated by the second pressure source can be replaced by a compression spring or pneumatic actuator for biasing the pin 14 toward its retracted position;
the blocking member can be slidably mounted to the body 12 for linear movement between its first and second positions;
the tension spring 26 can be replaced by a pneumatic spring or a pneumatic actuator for biasing the blocking member 20;
a housing may extend around the lock body 12;
the cam assembly 30 may operate along a generally horizontal axis rather than along a vertical axis;
the cam assembly 30 may be replaced by a lever assembly or other mechanism for manually moving the blocking member 20; and/or
manual control of the pneumatic supply may be provided for the pneumatic cylinder 18 and pneumatic actuator 24;
the secondary lock 50 can be mounted in the barrier 100.

1. A pneumatically operated barrier lock comprising:
a body;
a primary locking pin slidably mounted to the body for movement along a path between an extended position for engaging a catch operatively associated with said pneumatically operated barrier lock and a retracted position for disengaging the catch;
a pneumatic cylinder adapted for connection to a first pressure source and actuable on said primary locking pin for moving said primary locking pin between said extended position and said retracted position;
a first biasing apparatus for biasing said primary locking pin toward said retracted position; and
a blocking member movable between a first position and a second position, wherein in said first position said blocking member is clear of said path to allow retraction of said primary locking pin, and wherein in said second position said blocking member blocks said path to prevent retraction of said primary locking pin.

2-6. (canceled)

7. The pneumatically operated barrier lock according to claim 1, further comprising a second biasing apparatus for biasing said blocking member into said second position.

8. (canceled)

9. The pneumatically operated barrier lock according to claim 1, further comprising a second biasing apparatus for biasing said blocking member into said first position.

10. (canceled)

11. The pneumatically operated barrier lock according to claim 1, further comprising a pneumatic actuator for selectively moving said blocking member between said first position and said second position.

12. The pneumatically operated barrier lock according to claim 11, wherein said pneumatic actuator is adapted to receive pressure from a third pressure source.

13. (canceled)

14. The pneumatically operated barrier lock according to claim 11, wherein said pneumatic cylinder and said pneumatic actuator are both adapted to receive pressure from said first pressure source via respective valves.

15. The pneumatically operated barrier lock according to claim 12, further comprising a manually actuable cam assembly engageable with said blocking member to move said blocking member from said second position to said first position.

16. The pneumatically operated barrier lock according to claim 15, wherein said cam assembly is biased by said third pressure source away from engagement with said blocking member.

17. The pneumatically operated barrier lock according to claim 16, further comprising a third biasing apparatus biasing said cam assembly toward engagement with said blocking member, said third biasing apparatus being adapted to move said cam assembly into engagement with said blocking member upon pressure from said third pressure source falling below a predetermined level or upon disconnection of said third pressure source.

18. The pneumatically operated barrier lock according to claim 11, further comprising a controller for controlling application and disconnection of pressure to said pneumatic cylinder and to said pneumatic actuator from said first pressure source and/or said third pressure source.

19. (canceled)

20. (canceled)

21. The pneumatically operated barrier lock according to claim 18, further comprising at least one first proximity sensor for sensing the position of said primary locking pin, said controller being responsive to said at least one first proximity sensor.

22. The pneumatically operated barrier lock according to claim 18, further comprising at least one second proximity sensor for sensing the position of said blocking member, said controller being responsive to said at least one second proximity sensor.

23. The pneumatically operated barrier lock according to claim 18, wherein, upon receiving a locking command, said controller is adapted to:
control the application of pressure to said pneumatic cylinder to move said primary locking pin from the retracted position to the extended position;
move said blocking member into the second position; and
release pressure from said pneumatic cylinder.

24. The pneumatically operated barrier lock according to claim 23, wherein, upon receiving an unlocking command, said controller is adapted to:
control the application of pressure to said pneumatic cylinder;
move said blocking member into the first position; and
release pressure from said pneumatic cylinder.

25. A locking assembly comprising:
the pneumatically operated barrier lock according to claim 1;
a secondary lock including one or more secondary locking pins movable between a retracted position and an extended position,
wherein said primary locking pin is engageable with said secondary lock to drive said one or more secondary locking pins from their retracted position to their extended position.

26. The locking assembly according to claim 25, wherein said secondary lock comprises a plurality of said secondary locking pins and a mechanism actuable thereon, said mechanism being engageable by said primary locking pin to drive said secondary locking pins from their retracted position to their extended position.

27. (canceled)

28. A method of locking a barrier, said method comprising the steps of:
biasing a primary locking pin toward a retracted position;
applying a pneumatic pressure to said primary locking pin to drive said primary locking pin along a path from said retracted position into an extended position against said biasing to engage a catch operatively associated with said primary locking pin;
moving a blocking member from a first position free of said path into a second position blocking said path; and
removing said pneumatic pressure.

29. The method of locking a barrier according to claim 28, wherein upon removing said pneumatic pressure, and with the blocking member in said second position, said primary locking pin bears against said blocking member.
